(19) United States
(12) Patent Application Publication
(10) Pub. No.: US 2011/0137736 A1
(43) Pub. Date: Jun. 9, 2011

(54) Using social network activity to characterize viewers across multiple internet activities

(76) Inventors: Harry R. Soza, San Jose, CA (US); Mark Wayman, Oakland, CA (US); Keith Rose, Alamo, CA (US); Jeffrey A. Roberts, Hayward, CA (US)

(21) Appl. No.: 12/930,325

(22) Filed: Jan. 4, 2011

Related U.S. Application Data
(63) Continuation-in-part of application No. 12/288,614, filed on Oct. 21, 2008.
Application No. 12/288,614 is a continuation-in-part of application No. 12/460,223, filed on Jul. 14, 2009.
Application No. 12/460,223 is a continuation-in-part of application No. 12/804,248, filed on Jul. 16, 2010.
(60) Provisional application No. 61/335,317, filed on Jan. 4, 2010.

(51) Int. Cl. G06Q 30/00

(52) U.S. Cl. 705/14.73

(57) ABSTRACT

A system and method for characterizing viewers across multiple Internet activities is provided. A communication system communicates a personal identifier between a plurality of distant channels of promotions presented to a social network member of a social network communication system and a corresponding non-social network sponsoring business system of the promotions. A data analysis computer system tracks the personal identifier communications and generates a report to characterize the tracked data related to the promotions of the online non-social network sponsoring business system and the personal identifiers of the members.

### CROSS-REFERENCE TO RELATED APPLICATIONS

This application claims priority from U.S. Provisional Patent Application 61/335317 filed Jan. 4, 2010, which is incorporated herein by reference. This application is a continuation-in-part of U.S. patent application Ser. No. 12/288,614 filed Oct. 21, 2008, which is incorporated herein by reference. This application is also a continuation-in-part of U.S. patent application Ser. No. 12/460,223 filed July 14, 2009, which is incorporated herein by reference. This application is also a continuation-in-part of U.S. patent application Ser. No. 12/804,248 filed Jul. 16, 2010, which is incorporated herein by reference.

### FIELD OF THE INVENTION

The invention relates to Social Network (SN) systems and the characterization of viewers' actions across multiple Internet promotional channels or activities.

### BACKGROUND OF THE INVENTION

Businesses and other organizations often market promotions and other forms of sales materials to viewers using multiple Internet-enabled “channels”: website pages, banner ads, search engine responses, videos, direct emails, etc. The goal of these various forms and formats of promotion is to stimulate the viewer to take a desired business action such as a purchase or enrollment in a program of the sponsoring organization. Most promotional campaigns will use a variety of formats and channels, some contemporaneously and others in planned sequences, attempting to maximize the impact with the potential consumers. The invention advances the art of campaigns using a multi-channel promotional approach in a social network environment.

### SUMMARY AND DESCRIPTION OF THE INVENTION

Most promotional campaigns will use a variety of formats and channels, some contemporaneously and others in planned sequences, attempting to maximize the impact with the potential consumers. The core concept is that only some viewers will be stimulated to take the desired action by any single promotion (e.g. a press release about a new product) and that offering multiplicative channels and formats of promotion (e.g. video+sweepstakes+website) creates the potential of multiple/repetitive viewer impressions to stimulate additional potential consumers to take action.

When a promotional campaign uses a multi-channel environment it is of high business value to the sponsor to learn which specific promotions, or combinations of the promotions, have a greater impact with the viewers who take the desired action. For example, does the “press release+video” create more sales than the “search engine response+product features website” ? Discerning these patterns is of high value because it enables a sponsor to concentrate its promotional resources and spending to those channels and formats that are delivering business impact.

Each modern Internet marketing channel has capabilities to measure viewer use patterns and to report statistics about how potential consumers interacted within that single channel. For example, Internet video sites readily measure how many times a video was watched and the extent of each viewing; web pages can track which elements a viewer clicked on while on that page. However, a viewer's actions across multiple promotional channels is very difficult or impossible to track, primarily because of the inherent anonymity present in the open Internet.

To measure track viewer patterns across multiple Internet promotions, a consistent “Tracking ID” (TID) is needed. This consistent TID enables the various different marketing channels to cooperatively report cross-channel activity and identify sequences of viewer use. The TID may be unrelated to any actual identity information about the viewer.

In a Social Network [SN] each viewer is consistently identified with no explicit request to the User. According to an embodiment of the invention, from this SN identity a consistent Tracking ID can be assigned. When a SN viewer clicks on a link to leave the SN and go to a non-SN site, or conversely, comes to a SN site from a non-SN site, it is possible for the SN technology system to inform the non-SN site of the Tracking ID of the viewer. This enables the non-SN site to record the TID and correlate it to its own activity records. If the multiple promotional channels participating in a Sponsor's promotional campaign record these TIDs, critical new insights can be gained into consumer behavior, the impact of specific cross-channel marketing techniques, and the overall effectiveness of certain configurations of promotional channels.

Embodiments of the invention involve a computer system capable of identifying a social network User, using data provided by a social network, and assigning a consistent “Tracking ID” to that User.

Embodiments of the invention further involve a communications software program that is in compliance with the typical site-to-site communication messaging protocols used in the Internet, but which also enables cooperating Internet computer systems to identify each other and readily exchange and/or capture Tracking ID information.

Embodiments of the invention further involve a computer system, operating in a social network, that is capable of assigning, then attaching, embedding or encoding the Tracking ID into the normal Internet site-to-site communication messages.

Embodiments of the invention further involve an Internet site computer system, operating outside of a social network, that is capable of receiving the communications that contains the Tracking ID, then recognizing and utilizing it as a means of more robustly characterizing the activity records of that viewer on that Internet site.

Embodiments of the invention further involve a computer system, operating in a social network, that is capable of recording the Tracking ID as part of the activity and characterization records of social network activity of a viewer.

Embodiments of the invention further involve a data analysis system operable on a computer system capable of analyzing or combining the activity records from several separate Internet computer systems that have used the Tracking ID as a descriptive element characterizing the viewer. The separate computer systems that cooperatively share the activity records may be SN-based sites or non-SN sites. Among the types of reporting from such an analysis system is the ability to discern the pattern of activity of a single Tracking ID across the various separate Internet computer systems, and when combined with other single-Tracking ID patterns, present an aggregated view of business-relevant information.

In another aspect of the invention, in the realm of online merchants a system and method is provided with the capability to capture patterns of a cross-merchant activity. By using the each user's social network identification across a number of merchants, the computer system compiles a database of aggregate shopping behavior that can be correlated and analyzed. Over time these data reveal patterns and trends of how consumers behaviorally perceive certain merchants (e.g. discount, specialty, high-end) and which sets of merchants consumers regard as competitive or complementary to each other. Through this system, the merchants can gain behavioral insight into the effectiveness of their own promotions as they attempt to convey to consumers a positioning of their brand.

Some aspects of the technology have been described in, for example, U.S. patent application Ser. No. 12/288,614 filed on Oct. 21, 2008 and U.S. patent application Ser. No. 12/460,223 filed on July 14, 2009, which are both incorporated by reference to this patent application in its entirety.

Further details of embodiments of the invention are described in Appendix A (1 page) by the inventors, which is hereby incorporated in its entirety.

1. A system for characterizing viewers across multiple Internet activities, comprising:
(a) an online social network communication system with a plurality of social network members, wherein each of said social network members is assigned a personal identifier by a computer system operable within said online social network communication system, wherein said personal identifier prior to assignment is identified without any request to said member;
(b) an online non-social network sponsoring business system linked via the Internet with said online social network communication system and presenting a plurality of distinct channels of promotions to said social network members on a member's web page within said social network communication system; and
(c) a communication system for communicating said personal identifier between said plurality of distant channels of promotions presented to said social network member of said social network communication system and said corresponding non-social network sponsoring business system; and
(d) a data analysis computer system tracking said personal identifier communications of (c) and generating a report to characterize said tracked data related to said promotions of said online non-social network sponsoring business system and said personal identifiers of said members.
